(19) United States
(12) Patent Application Publication
(10) Pub. No.: US 2026/0208761 A1
(43) Pub. Date: Jul. 23, 2026

(54) Safety Self Talks (SST) by Large Language Model in Semi or Fully Autonomous Vehicles

(71) Applicant: FLORIDA ATLANTIC UNIVERSITY BOARD OF TRUSTEES, Boca Raton, FL (US)

(72) Inventor: Mehrdad Nojoumian, Boca Raton, FL (US)

(21) Appl. No.: 19/455,013

(22) Filed: Jan. 21, 2026

Related U.S. Application Data
(60) Provisional application No. 63/747,463, filed on Jan. 21, 2025.

(51) Int. Cl. B60W 60/00; B60W 50/14; G01S 13/931; G01S 17/931; G06T 7/11

(52) U.S. Cl. CPC B60W 60/001; B60W 50/14; G01S 13/931; G01S 17/931; G06T 7/11; B60W 2050/143; B60W 2050/146; B60W 2556/65

(57) ABSTRACT

Systems, methods, and devices described herein can be used to enhance vehicle safety and communication systems. An example method can include: monitoring data corresponding with the at least one vehicle's geographic location via one or more vehicle sensors, in response to receiving a request and/or detecting one or more conditions from analysis of the monitored data, initiating safety self-talk (SST) operations, wherein the SST operations comprise analyzing the monitored data using one or more Large Language Models (LLM); automatically initiating at least one driving action based, at least in part, on the analysis of the monitored data; and generating an output corresponding with the initiated action.

### CROSS-REFERENCE TO RELATED APPLICATIONS

This application claims priority to and the benefit of U.S. Provisional Application No. 63/747,463, titled “Safety Self Talks (SST) by Large Language Model in Semi or Fully Autonomous Vehicles,” filed on Jan. 21, 2025, the content of which is incorporated by reference herein in its entirety.

### BACKGROUND

Safety is a prominent challenge in the domain of semi and fully autonomous vehicle technology development as well as advanced driver-assistance systems.

As such, there is a need for improved safety and reliability of such systems. These needs and others are at least partially satisfied by the present disclosure.

### SUMMARY

Safety actions of human drivers are often formed after self-assessments of the driving situations by the driver. For instance, when a driver observes several vehicles pressing their brakes, as reflected in the brake lights, the driver may ask themselves “What is happening? Am I approaching a construction zone? Is there an accident on the road?” and so on. This continuous safety self-talk is the main initiative of the subsequent safety actions taken by the driver. As the driver observes the environment and gains more information, this safety self-talk will be continued along with analytical assessments of the situation by the driver. This conversation might be a joint conversation with other passengers in the vehicle.

Embodiments of the present disclosure provide a new technology emulating the aforementioned Safety Self-Talks (SST) based on Large Language Models (LLM) in Semi or Fully Autonomous Vehicles. Large Language Models are mainly used in two contexts in autonomous driving technologies: (a) For vehicle-passengers'interactions, e.g., to interact with the infotainment systems, and (b) For Artificial Intelligence (AI) explainability, e.g., to analyze the situation and provide reasons for actions taken by the autopilot software. For instance, “I'm changing my lane since the front vehicle moves below the speed limit” or “there is an obstacle in the current lane”. However, the proposed technology utilizes LLMs to trigger safety self-talk to better assess the driving situation, and consequently, offers proper actions to the autopilot software. In other words, as soon as there is a red flag or inconsistencies among observations of sensors, which is managed by sensor fusion techniques, the autopilot initiates a safety self-talk to further assess the situation using LLMs. Subsequently, the proper actions are proposed to the autopilot software using LLMs. The art will utilize existing image segmentation techniques using LLMs to have a better understanding and assessment of the situation and to drive proper actions. Also, the utilized LLM can be specifically trained and customized for safety self-talks based on a large class of driving scenarios and causation behind accidents, e.g., common reasons for accidents on roads. Moreover, different machine learning techniques can be utilized to improve safety self-talks. This technology can be extended to analyze other sources of sensory information besides images of cameras, e.g., self-talks on radar, sonar, or lidar information. Furthermore, the proposed technology can be used in the context of cooperative driving among semi or fully autonomous vehicles as well as human-driving vehicles. Furthermore, other language processing techniques can be utilized alongside LLMs. The system consists of (1) The AV's existing devices (e.g., light detection and ranging (LiDAR) sensor(s), short range radio detection and ranging (RADAR) sensor(s), sonar, cameras, etic) and cloud/AV's computing infrastructure to collect data and analyze it; (2) Cloud and/or local storage to store real-time data, of all kinds from all sources, regarding driving situations; and (3) Algorithms to initiate and process safety self-talk using LLMs whenever it's necessary inside the vehicle or in cooperation with other vehicles using existing communication platforms.

In some implementations, a vehicle system is provided. The vehicle system can include: at least one vehicle, the at least one vehicle including: at least one processor in electronic communication with the at least one vehicle; and a memory having instructions thereon, wherein the instructions when executed by the processor, cause the processor to: monitor data corresponding with the at least one vehicle's geographic location via one or more vehicle sensors; in response to receiving a request and/or detecting one or more conditions (e.g., sensor inconsistencies or predicted risks) from analysis of the monitored data, initiate safety self-talk (SST) operations, wherein the SST operations include analyzing the monitored data using one or more Large Language Models (LLM); automatically initiate at least one driving action based, at least in part, on the analysis of the monitored data; and generate an output corresponding with the initiated action.

In some implementations, the at least one driving action includes changing the at least one vehicle's route or position, speed, or heading.

In some implementations, the generated output includes one or more of an alert, auditory and/or textual information summarizing or explaining the at least one driving action.

In some implementations, the instructions when executed by the processor cause the processor to further: receive auditory and/or textual information from a vehicle passenger; incorporate the received auditory and/or textual information into the SST operations; and perform at least a second driving action.

In some implementations, the instructions when executed by the processor cause the processor to further: responsive to detecting the one or more conditions, obtain additional data for the analysis via the one or more vehicle sensors.

In some implementations, the vehicle sensors include at least one of infrared camera(s), light detection and ranging (LiDAR) sensor(s), short range radio detection and ranging (RADAR) sensor(s).

In some implementations, the instructions when executed by the processor cause the processor to further: responsive to detecting the one or more conditions, obtain additional data for the analysis from one or more other vehicles, computing systems, cloud-computing systems, and/or databases.

In some implementations, the one or more LLMs are trained using historical vehicle data for a plurality of vehicles.

In some implementations, the historical vehicle data describes a plurality of classes of driving scenarios and associated accident or driving information.

In some implementations, the one or more conditions are detected using sensor fusion operations.

In some implementations, the SST operations include using machine vision and/or image segmentation techniques.

In some implementations the instructions when executed by the processor cause the processor to further: transmit at least a portion of the generated output to another computing system or vehicle.

In some implementations, the analysis is based, at least in part, on real-time vehicle data obtained from one or more other vehicles.

In some implementations, the at least one vehicle is an autonomous or semi-autonomous vehicle.

In some embodiments, a cooperative driving system is provided. The cooperative driving system can include: a plurality of vehicles in electronic communication with one another, each vehicle including: at least one vehicle sensor; a processor in electronic communication with the at least one vehicle sensor; and a memory having instructions thereon, wherein the instructions when executed by the processor, cause the processor to: monitor data corresponding with the respective vehicle's geographic location via the at least one vehicle sensor; in response to receiving a request and/or detecting one or more conditions from analysis of the monitored data, initiate safety self-talk (SST) operations, wherein the SST operations include analyzing the monitored data using one or more Large Language Models (LLM); automatically initiate at least one driving action based, at least in part, on the analysis of the monitored data; and generate an output corresponding with the initiated action.

In some implementations, each of the plurality of vehicles is further configured to: responsive to detecting the one or more conditions, obtain additional data for the analysis via the one or more vehicle sensors.

In some implementations, the techniques described herein relate to a cooperative driving system, wherein each vehicle is an autonomous or semi-autonomous vehicle.

In some embodiments, a computer-implemented method is provided. The computer-implemented method can include: monitoring data corresponding with at least one vehicle's geographic location via one or more vehicle sensors; in response to receiving a request and/or detecting one or more conditions from analysis of the monitored data, initiating safety self-talk (SST) operations, wherein the SST operations include analyzing the monitored data using one or more Large Language Models (LLM); automatically initiating at least one driving action based, at least in part, on the analysis of the monitored data; and generating an output corresponding with the initiated action.

In some implementations, a non-transitory computer readable medium is provided. The non-transitory computer readable medium can include a memory having instructions stored thereon to cause a processor to: monitor data corresponding with at least one vehicle's geographic location via at least one vehicle sensor; in response to receiving a request and/or detecting one or more conditions from analysis of the monitored data, initiate safety self-talk (SST) operations, wherein the SST operations include analyzing the monitored data using one or more Large Language Models (LLM); automatically initiate at least one driving action based, at least in part, on the analysis of the monitored data; and generate an output corresponding with the initiated action.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

The components in the drawings are not necessarily to scale relative to each other. Like reference, numerals designate corresponding parts throughout the several views.

FIG. 1 is an example system in accordance with certain embodiments of the present disclosure.

FIG. 2 is flowchart diagram illustrating a method in accordance with certain embodiments of the present disclosure.

FIG. 3 is an example system in accordance with certain embodiments of the present disclosure.

FIG. 4 is an example computing device.

### DETAILED DESCRIPTION

It is appreciated that certain features of the disclosure, which are, for clarity, described in the context of separate embodiments, can also be provided in combination with a single embodiment. Conversely, various features of the disclosure, which are, for brevity, described in the context of a single embodiment, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Definitions

In this specification and in the claims that follow, reference will be made to a number of terms, which shall be defined to have the following meanings:

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various embodiments, elements, and features of the disclosure also include the more limited embodiments of “consisting essentially of” and “consisting of.”

As used herein, the singular forms “a,” “an,” and “the” include plural referents unless the context clearly dictates otherwise. Thus, for example, reference to a “sensing device” includes embodiments having two or more such sensing devices unless the context clearly indicates otherwise.

Ranges can be expressed herein as from “about” one particular value and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as,” and grammatical equivalences thereof, the phrase “and without limitation” is understood to follow unless explicitly stated otherwise.

As used herein, the terms “data,” “content,” “information,” and similar terms may be used interchangeably to refer to data capable of being transmitted, received and/or stored in accordance with embodiments of the present invention.

Safety is a paramount concern in the development of semi and fully autonomous vehicles (AVs) and advanced driver-assistance systems. While existing safety technologies are essential, human drivers play a crucial role in ensuring safe driving. Drivers often make safety decisions based on self-assessments of the driving situation. For instance, when a driver sees multiple vehicles braking, they might question the reason, such as an upcoming construction zone or an accident. This continuous internal dialogue, or safety self-talk, drives subsequent safety actions. As the driver gathers more information, this self-talk evolves alongside analytical assessments of the situation. It may even involve discussions with other passengers.

Embodiments of the present disclosure include Safety Self-Talk (SST) operations which leverage Large Language Models (LLMs) to emulate this human-like reasoning process in autonomous vehicles (AVs). Currently, LLMs are used in AVs for vehicle-passenger interactions and AI explainability. SST, however, would utilize LLMs to initiate safety self-talk, enabling the AV to better assess driving situations and make informed decisions. When sensors detect inconsistencies or potential risks, the AV's autopilot triggers SST, prompting the LLM to analyze the situation and propose appropriate actions.

Image segmentation techniques can be employed to enhance the effectiveness of SST and improve the AV's understanding of the driving environment. The LLM can be specifically trained on a vast dataset of driving scenarios and accident causes to refine its safety self-talk capabilities. Machine learning techniques can further optimize the process. Additionally, SST can be extended to analyze information from various sensors, such as RADAR, sonar, and LiDAR.

This technology has the potential to revolutionize cooperative driving, enabling AVs to communicate and coordinate with each other and with human-driven vehicles. By combining LLMs with other language processing techniques, SST can further enhance the safety and efficiency of autonomous driving. SST can integrate seamlessly with AVs'existing hardware and software infrastructure, leveraging sensors, cloud computing, and local storage to collect, analyze, and process real-time data. By initiating and processing safety self-talk, the technology can significantly improve the safety and reliability of AVs.

### Commercial Applications

The commercial applications of SST are primarily focused on the automotive industry, particularly in the development and deployment of autonomous AVs.

Enhanced Safety in Autonomous Vehicles: (i) Mitigating Unforeseen Circumstances: SST can help AVs better respond to complex, unexpected situations, improving overall safety. (ii) Improving Decision-Making: By simulating human-like reasoning, SST can lead to more informed and prudent decisions by the AV's autopilot. (iii) Addressing Edge Cases: SST can help bridge the gap between well-defined driving scenarios and the countless edge cases that can arise on the road.

Building Trust with Human Drivers: (i) Transparency and Explainability: SST can provide clear explanations for the AV's actions, fostering trust and understanding. (ii) Reducing Anxiety: By demonstrating that the AV is actively analyzing the situation and considering potential risks, SST can alleviate concerns about AV safety.

Advancing Cooperative Driving: (i) Enhanced Vehicle-to-Vehicle Communication: SST can facilitate more effective communication between AVs, enabling them to share information and coordinate their actions. (ii) Improved Traffic Flow and Safety: By working together, AVs equipped with SST can optimize traffic flow and reduce the risk of accidents. (iii) In addition to these core applications, SST technology could potentially be adapted for other industries that rely on autonomous systems, such as: (i) Robotics: Enhancing the decision-making capabilities of robots in industrial settings or in healthcare environments. (ii) Drones: Improving the safety and autonomy of drones for delivery, surveillance, or other applications. (iii) Aerospace: Enhancing the safety and reliability of autonomous flight systems.

The proposed SST technology can enhance safety, reliability, and user acceptance of autonomous systems. In some implementations, the proposed technology can utilize LLMs to trigger safety self-talk to better assess the driving situation and, consequently, offer proper recommendations to the autopilot software for taking action. In other words, as soon as there is a red flag or inconsistencies among observations of sensors, which is managed by sensor fusion techniques, the autopilot initiates a safety self-talk to further assess the situation using LLMs. Subsequently, the proper actions are proposed for the autopilot software using LLMs. This new technology would utilize existing image segmentation techniques using LLMs to have a better understanding and assessment of the situation and to drive proper actions. Also, the utilized LLM can be specifically trained and customized for safety self-talks based on a large class of driving scenarios and causation behind accidents, i.e., common reasons for accidents on roads. Moreover, different machine learning techniques can be utilized to improve safety self-talk. This technology can be extended to analyze other sources of sensory information besides images of cameras, e.g., self-talks on radar, sonar, or lidar information. Furthermore, the proposed technology can be used in the context of cooperative driving among semi or fully autonomous vehicles as well as human-driving vehicles. Furthermore, other language processing techniques can be utilized alongside LLMs. Sensor fusion techniques can be utilized to accurately perceive the driving environment and provide reliable input to the SST system.

An example system can include: (1) The AV's existing devices (e.g., RADAR, LiDAR, sonar, cameras, etc.) and cloud/AV's computing infrastructure to collect data and analyze it; (2) Cloud and/or local storage to store real-time data of all kinds from all sources, regarding driving situations; and (3) Algorithms to initiate and process safety self-talk using LLMs whenever it's necessary inside the vehicle or in cooperation with other vehicles using existing communication platforms. The proposed system and method can lead to analytical reasoning and understanding (e.g., hypotheses, conclusions) in addition to communication, and will add a new dimension of insight and understanding of semi/fully autonomous systems including vehicles, robots, surgical robots, care-giving robots, manufacturing robots, drone systems, flight systems, and/or the like. The example system can employ and leverage linguistic theories to develop, generate, and add new features over time.

### Example System

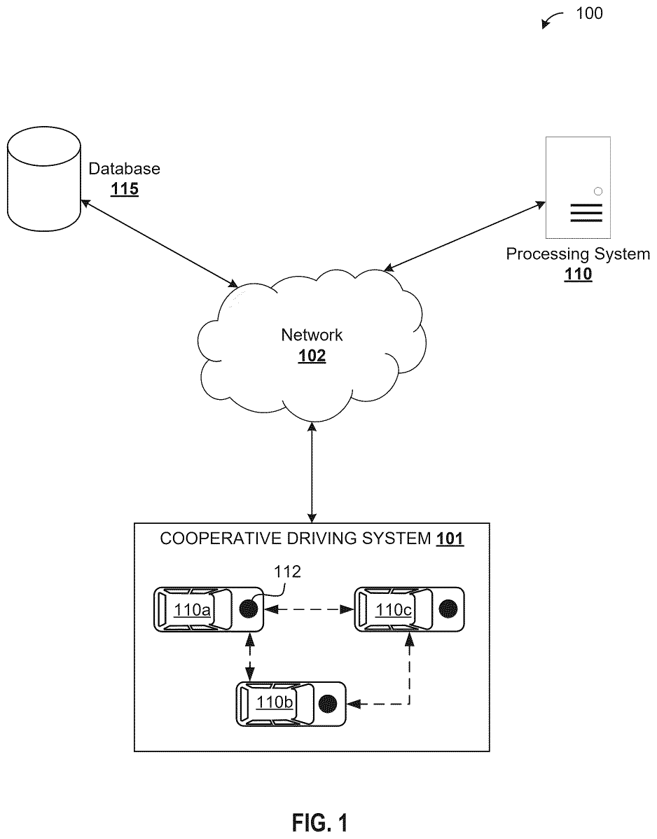

FIG. 1 is an example system 100 in accordance with certain embodiments of the present disclosure. As shown in FIG. 1, the system 100 includes a processing system 110 or device (e.g., cloud-based processing system) configured to communicate with a cooperative driving system 101. In various implementations, the processing system 110 and the cooperative driving system 101 are configured to transmit data to and receive data from one another over a network 102. The system 100 can include one or more databases, data stores, repositories, and the like. As shown, the system 100 includes database(s) 115 in communication with the cooperative driving system 101 and the processing system 110. In some implementations, the database(s) 115 can be hosted by the processing system 110.

In some implementations, as illustrated, the cooperative driving system 101 comprises a plurality of cooperative vehicles 110a, 110b, 110c (e.g., autonomous vehicles, semi-autonomous vehicles, or combinations thereof) in electronic communication with one another. For example, the cooperative driving system 101 can comprise a plurality of autonomous vehicles each using machine vision/image segmentation operations and techniques to navigate its environment. The present disclosure contemplates that the cooperative driving system 101 is not limited to the example depicted in FIG. 1 and can comprise autonomous and semi-autonomous robots, surgical robots, care-giving robots, manufacturing robots, drone systems, flight systems, and/or the like in electronic communication with one another.

As further described herein, each of the plurality of cooperative vehicles 110a, 110b, 110c can include one or more sensing devices configured to monitor and/or obtain real-time information/data from the environment (e.g., image data, video data, audio data, vehicle data, body data from one or more individuals, environmental data (e.g., temperature, pressure) and the like). For example, as shown, the first cooperative vehicle 110a comprises at least one sensing device 112. The sensing device(s) 112 can be or comprise one or more optical devices, advanced cameras and/or sensors that may utilize high dynamic range (HDR) imaging and adaptive exposure control. The example sensing device(s) 112 can also include infrared cameras, light detection and ranging (LiDAR) sensor(s), short range radio detection and ranging (RADAR) sensor(s), or combinations thereof.

By way of example, each of the plurality of cooperative vehicles 110a, 110b, 110c can be configured to obtain data from its environment that can in turn be used to facilitate safety self-talk operations based on, for example, the vehicle's environmental conditions. Further, each of the plurality of cooperative vehicles 110a, 110b, 110c can generate and transmit indications to one or more other vehicles within a predetermined range based on the outputs of the safety self-talk operations. These indications can be used to trigger actions by the other vehicles. In some implementations, a given vehicle can transmit such information to a server (e.g., processing system 110) where it may be stored in a database 115 for subsequent analysis, to update one or more maps, and/or used to generate and send indications to vehicles in communication therewith or in response to requests for such information.

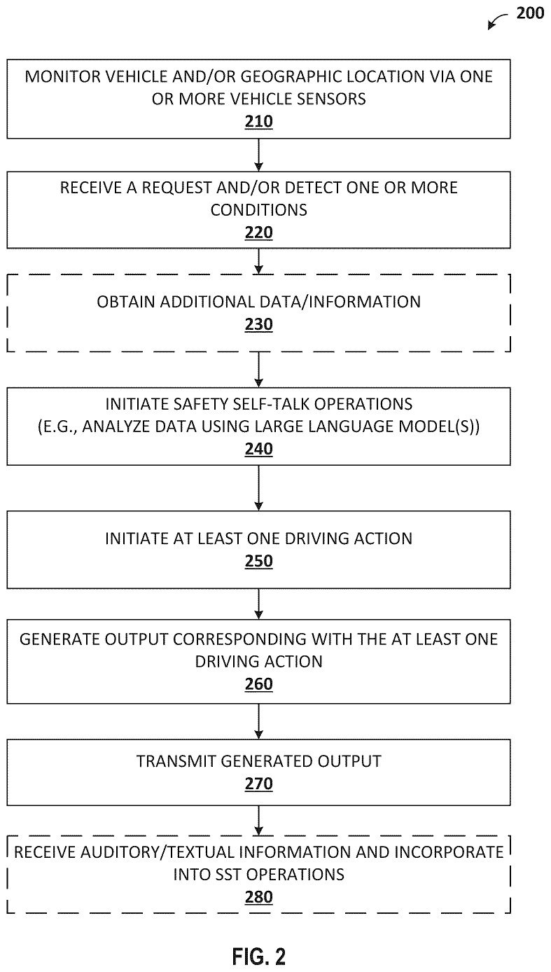

Referring now to FIG. 2, a flowchart diagram depicting a method 200 that includes performing safety self-talk operations to enhance vehicle safety and support communication between a driving system and passengers of autonomous or semi-autonomous vehicles (e.g., autopilot software). The method 200 can facilitate modifying or dynamically adjusting a driving route and/or parameters in real time based on detected conditions. This disclosure contemplates that the example method 200 can be performed using one or more computing devices (e.g., at least the configuration illustrated in FIG. 4 by box 402) and/or at least partially by a cooperative driving system 101 described in connection with FIG. 1.

At step/operation 210, the method 200 includes monitoring a vehicle, for example, the vehicle's geographic location/the vehicle's environment. In some implementation, step/operation 210 includes obtaining data, such as, but not limited to, image data/video data via at least one sensing device 112 described above in connection with FIG. 1. As described above, the at least one sensing device 112 may be operatively coupled to or a component of a cooperative driving system such as an autonomous vehicle or semi-autonomous vehicle. The at least one sensing device 112 can be or comprise one or more optical devices, image sensors, location sensors (such as a global positioning system (GPS) sensor), camera(s), two dimensional (2D) and/or three dimensional (3D) light detection and ranging (LiDAR) sensor(s), long, medium, and/or short range radio detection and ranging (RADAR) sensor(s), ultrasonic sensors, electromagnetic sensors, (near-) infrared (IR) cameras, 3D cameras, 360° cameras, accelerometer(s), gyroscope(s), and/or other sensors that enable the vehicle to determine one or more features of the corresponding surroundings, and/or other components configured to perform various operations, procedures, functions or the like described herein. In some implementations, the method 200 includes obtaining real-time road information or historical vehicle data from the vehicle and/or for one or more other vehicles.

At step/operation 220, the method 200 includes receiving a request and/or detecting one or more conditions based on the monitored data. For example, a vehicle passenger can ask the vehicle system to explain a recent action or change (e.g., lane change, speed change). In other implementations, the vehicle system detects a change in driving conditions, for example, detected via sensor fusion operations associated with the vehicle's sensors. In some examples, the one or more conditions are determined based, at least in part, on occurred events (e.g., another car changing lanes, slowing down, or speeding up), sensor inconsistencies, or predicted risks based on historical information associated with the geographic location.

Optionally, at step/operation 230, the method 200 includes obtaining (e.g., requesting, retrieving) additional data/information corresponding with the vehicle and/or the vehicle's geographic location, for example, from one or more databases (e.g., public databases, private databases), one or more other vehicles, cloud computing systems, or the like. By way of example, in order to validate the one or more detected conditions, the vehicle system can actuate additional sensors to obtain additional data or request data (e.g., image data, real-time driving parameters from nearby vehicles). Notably, the vehicle system can conserve computational resources by obtaining additional information only when required for its analysis. For example, the vehicle system can use image sensors for continuous monitoring and activate additional sensors (e.g., LiDAR sensors, RADAR sensors) when required for further analysis.

At step/operation 240, the method 200 includes initiating safety self-talk (SST) operations based on the analysis of the monitored data. The SST operations can comprise analyzing at least a portion of the monitored data using one or more Large Language Models (LLMs). The LLMs can be trained using historical vehicle data that describes a plurality of classes of driving scenarios and associated accident and/or risk information. Additionally, the one or more LLMs (or other models) can be trained based, at least in part, on historical vehicle data, traffic data, accident data, or combinations thereof. In some implementations, the SST operations include employing machine vision and/or image segmentation techniques. This disclosure contemplates that SST operations can be triggered in response to an incident (e.g., receiving a phone call, detecting an accident) or hearing a passenger's voice. SST operations can also be initiated randomly, periodically (e.g., every hour, every 30 minutes, every 15 minutes), or based on other triggers. SST operations can be used by AVs or other fully/semi-autonomous systems to analyze and detect any unusual activities/incidents in various domains such as transportation, manufacturing, care-giving robots, and the like, including but not limited to: (a) detection of cybersecurity attacks against a vehicle, a group of vehicles, or road infrastructures, (b) critical weather condition, (c) natural disasters, (d) failures of other systems or robotic partners (in the manufacturing context), (e) a person falling (in the care-giving context), and the like. In some embodiments, a user can pre-select incident types that will trigger SST operations and/or select a frequency/cadence for such operations.

At step/operation 250, the method 200 includes initiating at least one driving action based, at least in part on the analysis of the monitored data and/or additional data. A driving action can be or comprise a change in the vehicle's route, position, speed, heading, and/or the like.

At step/operation 260, the method 200 includes generating an output corresponding with the at least one driving action. The output can comprise an alert, auditory and/or textual information summarizing or explaining the at least one driving action. In some embodiments, the vehicle system can communicate directly with the vehicle passenger(s) to provide the information, and answer any following questions.

At step/operation 270, the method 200 includes transmitting at least a portion of the generated output to another computing system, databases, and/or one or more other vehicles (e.g., as part of a cooperative driving system). Such outputs can be used to inform third-party systems (e.g., mapping or navigation systems). Step/operation 270 can include transmitting an indication of the generated output to vehicles within a predetermined range of the vehicle or to a central server.

At step/operation 280, the method 200 includes receiving auditory and/or textual information from a vehicle passenger. The vehicle system can incorporate the received auditory and/or textual information into the SST operations and perform at least a second driving action, if necessary. For example, the vehicle system can explain at step/operation 270 that “I changed lanes because the car in front of me slowed down.” The vehicle passenger can respond by saying “I think you should switch back to the other lane because the cars further ahead are not moving as quickly as they are in the lane you switched from.” The vehicle system can incorporate this new information into its SST operations, may obtain additional data to validate the auditory and/or textual information, and proceed to switch back to its original lane based on further analysis confirming that there is slower traffic in the lane it had moved to. However, if the vehicle system determines that the passenger's information is inaccurate, the vehicle system can provide additional information indicating that it recommends staying in the present lane based on additional data/analysis. Accordingly, vehicle passengers can augment and appreciate the reasoning behind vehicle system operations in real-time.

### Example Implementation

In one implementation, the proposed method (e.g., method 200 discussed in relation to FIG. 2) includes obtaining one or more videos from a traffic incident. Exemplary traffic incidents can include a construction zone, a rush hour traffic jam, or collision (accidents with different severity levels). The video(s) can be obtained via camera(s) or sensor(s) of a subject vehicle. In some embodiments, the method includes extracting key image data (e.g., 7-10 frames/pictures) from the one or more videos. Subsequent to extracting the image data, the method includes using an AI tool (discussed in more detail below) to explain what each frame/picture shows based on the proper order. By way of example, the AI tool can determine that a first picture shows a red car colliding with a white truck. The AI tool can also be used to determine environmental details/characteristics (e.g., this is a two-lane highway, a number of vehicles in the area, the average speed of surrounding vehicles, and/or the like) for other frames/pictures from the same traffic incident. These findings will be used in a prompt engineering tool to initiate a conversation with a Large Language Model (LLM), which is specifically trained based on traffic incidents and data. The conversation can continue until proper actions are recommended to the subject vehicle/autopilot software with various levels of autonomy, for example, (A) change your lane and take the first exit, (B) immediately go to the non-occupied shoulder of the road due to safety, (C) slow down and go to the right. In various implementations, this conversation can be between the subject vehicle and itself using the LLM (self-talk), the subject vehicle and other surrounding vehicles, or the subject vehicle and passengers within the vehicle.

### Example System

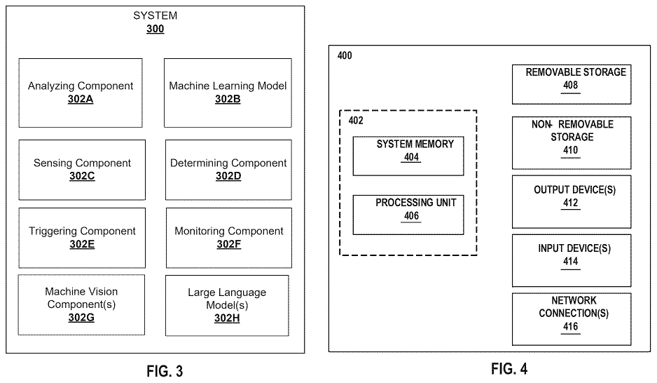

Referring now to FIG. 3, an example system 300 is shown. The system 300 can be configured to perform the method 200 described above in connection with FIG. 2. In various implementations, the system 300 is embodied as a vehicle, computing device, or remote server. For example, the system 300 may be located remotely from a vehicle, while in other embodiments, the system 300 and the vehicle may be collocated, such as within the vehicle. Each of the components of the system, may be in communication with one another over the same or different wireless or wired networks including, for example, a wired or wireless Personal Area Network (PAN), Local Area Network (LAN), Metropolitan Area Network (MAN), Wide Area Network (WAN), cellular network, and/or the like. In some embodiments, a network may comprise the automotive cloud, digital transportation infrastructure (DTI), radio data system (RDS)/high-definition radio (HD) or other digital radio system, and/or the like. For example, a vehicle may be in communication with the system 300 via the network and/or via the Cloud. In the example shown in FIG. 3, the system 300 includes analyzing component(s) 302A, machine learning model(s) 302B, sensing component(s) 302C, determining component(s) 302D, triggering component(s) 302E, monitoring component(s) 302F, machine vision component(s) 302G, and one or more Large Language Models 302H.

### Example Sensing Device

As detailed herein, an example vehicle can include one or more sensing devices that in turn comprise camera(s), sensor(s), and the like.

Advanced cameras and sensors: Autonomous vehicles are increasingly being equipped with high-resolution cameras and sensors. These cameras and sensors use a variety of techniques, such as high dynamic range (HDR) imaging and adaptive exposure control.

Infrared cameras: Infrared cameras can detect heat radiation. This technology has the potential to significantly improve the performance of autonomous vehicles in various conditions.

LiDAR: LiDAR is a laser-based technology that can create a 3D map of the surrounding environment. This map can be used to identify objects and road markings.

RADAR: RADAR is a radio-based technology that can detect objects by measuring the reflection of radio waves. RADAR can be used to identify objects and road markings.

### Machine Learning

In addition to the machine learning operation described above, the exemplary system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, transformer-based models (e.g., Bidirectional Encoder Representations from Transformers (BERT), Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down-sampling). A fully-connected layer includes neurons, where each neuron is connected to all of the neurons in the previous layer. The layers are stacked similar to traditional neural networks. GCNNs are CNNs that have been adapted to work on structured datasets such as graphs.

A Large Language Model (LLM) is a model/AI that is configured to generate human-readable textual data based on received inputs. Such models can be used to answer questions, summarize text, generate novel content, or independently converse with users. An example LLM can be trained on large volumes of textual data and utilizes deep learning to generate natural language outputs. This disclosure contemplates the use of LLMs to analyze data from a vehicle and/or the vehicle's environment in order to generate audible or textual outputs for an end user. By way of example, subsequent to analyzing a particular situation, the proposed SST system (comprising one or more LLMs) can be employed to explain the reasons for the actions taken by autopilot software. For instance, “I am changing my lane since the front vehicle is moving below the speed limit” or “I am changing my lane because there is an obstacle in the current lane up ahead”. Additionally, and/or alternatively, the SST system can interact with or communication such information directly to vehicle passengers.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

### Computing Devices and Methods of Use

It should be appreciated that the logical operations described herein with respect to the various figures may be implemented (1) as a sequence of computer-implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special-purpose digital logic, and any combination thereof. It should also be appreciated that more or fewer operations may be performed than shown in the figures and described herein. These operations may also be performed in a different order than those described herein.

Referring to FIG. 4, an example computing device 400 upon which embodiments of the present disclosure may be implemented is illustrated. It should be understood that the example computing device 400 is only one example of a suitable computing environment upon which embodiments of the present disclosure may be implemented. Optionally, the computing device 400 can be a well-known computing system including, but not limited to, personal computers, servers, handheld or laptop devices, multiprocessor systems, microprocessor-based systems, personal network computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, the computing device 400 typically includes at least one processing unit 406 and system memory 404. Depending on the exact configuration and type of computing device, system memory 404 may be volatile (such as random-access memory (RAM)), non-volatile (such as read-only memory (ROM), flash memory, etc.), or some combination of the two. This most basic configuration is illustrated in FIG. 4 by the dashed line 402. The processing unit 406 may be a standard programmable processor that performs arithmetic and logic operations necessary for the operation of the computing device 400. The computing device 400 may also include a bus or other communication mechanism for communicating information among various components of the computing device 400.

Computing device 400 may have additional features/functionality. For example, the computing device 400 may include additional storage such as removable storage 408 and non-removable storage 410 including, but not limited to magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412, such as a display, speakers, printer, etc., may also be included. The additional devices may be connected to the bus in order to facilitate communication of data among the components of the computing device 400. All these devices are well-known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example of tangible, computer-readable media may include but is not limited to, volatile media, non-volatile media, removable media and non-removable media implemented in any method or technology for storage of information such as computer-readable instructions, data structures, program modules or other data. System memory 404, removable storage 408, and non-removable storage 410 are all examples of tangible computer storage media. Examples of tangible, computer-readable recording media include but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain embodiments or portions thereof, may take the form of program code (i.e., instructions) embodied in tangible media or removable storage media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high-level procedural or object-oriented programming language to communicate with a computer system. However, the program(s) can be implemented in assembly or machine language if desired. In any case, the language may be a compiled or interpreted language, and it may be combined with hardware implementations.

In one embodiment, disclosed herein is a non-transitory computer-readable storage medium comprising instructions that, when executed, cause at least one processor to perform the method of any preceding embodiments.

Although certain implementations may refer to utilizing aspects of the presently disclosed subject matter in the context of one or more stand-alone computer systems, the subject matter is not so limited but rather may be implemented in connection with any computing environment. For example, the components described herein can be hardware and/or software components in a single or distributed systems, or in a virtual equivalent, such as, a cloud computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

What is claimed is:

1. A driving system comprising:
at least one vehicle, the at least one vehicle comprising:
at least one processor in electronic communication with the at least one vehicle; and
a memory having instructions thereon, wherein the instructions when executed by the at least one processor, cause the at least one processor to:
monitor data corresponding with the at least one vehicle's geographic location via one or more vehicle sensors;
in response to receiving a request and/or detecting one or more conditions from analysis of the monitored data, initiate safety self-talk (SST) operations, wherein the SST operations comprise analyzing the monitored data using one or more Large Language Models (LLM);
automatically initiate at least one driving action based, at least in part, on the analysis of the monitored data; and
generate an output corresponding with the initiated action.

2. The vehicle system of claim 1, wherein the at least one driving action comprises changing the at least one vehicle's route or position, speed, and/or heading.

3. The vehicle system of claim 1, wherein the generated output comprises one or more of an alert, auditory and/or textual information summarizing or explaining the at least one driving action.

4. The vehicle system of claim 1, wherein the instructions when executed by the processor cause the processor to further:
receive auditory and/or textual information from a vehicle passenger;
incorporate the received auditory and/or textual information into the SST operations; and
perform at least a second driving action.

5. The vehicle system of claim 1, wherein the instructions when executed by the processor cause the processor to further:
responsive to detecting the one or more conditions, obtain additional data for the analysis via the one or more vehicle sensors.

6. The vehicle system of claim 5, wherein the vehicle sensors include at least one of infrared camera(s), light detection and ranging (LiDAR) sensor(s), short range radio detection and ranging (RADAR) sensor(s).

7. The vehicle system of claim 1, wherein the instructions when executed by the processor cause the processor to further:
responsive to detecting the one or more conditions, obtain additional data for the analysis from one or more other vehicles, computing systems, cloud-computing systems, and/or databases.

8. The vehicle system of claim 1, wherein the one or more LLMs are trained using historical vehicle data for a plurality of vehicles.

9. The vehicle system of claim 8, wherein the historical vehicle data describes a plurality of classes of driving scenarios and associated accident or driving information.

10. The vehicle system of claim 1, wherein the one or more conditions are detected using sensor fusion operations.

11. The vehicle system of claim 1, wherein the SST operations comprise using machine vision and/or image segmentation techniques.

12. The vehicle system of claim 1, wherein the instructions when executed by the processor cause the processor to further:
transmit at least a portion of the generated output to another computing system or vehicle.

13. The vehicle system of claim 1, wherein the analysis is based, at least in part, on real-time vehicle data obtained from one or more other vehicles.

14. The vehicle system of claim 1, wherein the at least one vehicle is an autonomous or semi-autonomous vehicle.

15. A cooperative driving system comprising:
a plurality of vehicles in electronic communication with one another, each vehicle comprising:
at least one vehicle sensor;
a processor in electronic communication with the at least one vehicle sensor; and
a memory having instructions thereon, wherein the instructions when executed by the processor, cause the processor to:
monitor data corresponding with the respective vehicle's geographic location via the at least one vehicle sensor;
in response to receiving a request and/or detecting one or more conditions from analysis of the monitored data, initiate safety self-talk (SST) operations, wherein the SST operations comprise analyzing the monitored data using one or more Large Language Models (LLM);
automatically initiate at least one driving action based, at least in part, on the analysis of the monitored data; and
generate an output corresponding with the initiated action.

16. The cooperative driving system of claim 15, wherein each of the plurality of vehicles is further configured to:
responsive to detecting the one or more conditions, obtain additional data for the analysis via the one or more vehicle sensors.

17. The cooperative driving system of claim 15, wherein each vehicle is an autonomous or semi-autonomous vehicle.

18. A non-transitory computer readable medium comprising a memory having instructions stored thereon to cause a processor to:
monitor data corresponding with at least one vehicle's geographic location via at least one vehicle sensor;
in response to receiving a request and/or detecting one or more conditions from analysis of the monitored data, initiate safety self-talk (SST) operations, wherein the SST operations comprise analyzing the monitored data using one or more Large Language Models (LLM); and
automatically initiate at least one driving action based, at least in part, on the analysis of the monitored data; and
generate an output corresponding with the initiated action.

19. The non-transitory computer readable medium of claim 18, wherein the at least one driving action comprises changing the at least one vehicle's route or position, speed, and/or heading.

20. The non-transitory computer readable medium of claim 18, wherein the generated output comprises one or more of an alert, auditory and/or textual information summarizing or explaining the at least one driving action.
